(19) United States
(12) Patent Application Publication
(10) Pub. No.: US 2011/0002781 A1
(43) Pub. Date: Jan. 6, 2011

(54) WIND TURBINE WITH PRESSURE PROFILE AND METHOD OF MAKING SAME

(75) Inventors: Walter M. Presz, JR., Wilbraham, MA (US); Michael J. Werle, West Hartford, CT (US); Thomas J. Kennedy, III, Wilbraham, MA (US); William Scott Keeley, Charleston, RI (US); Robert Dold, Monson, MA (US); Timothy Hickey, Chicopee, MA (US)

Correspondence Address: FAY SHARPE LLP, 1228 Euclid Avenue, 5th Floor, The Halle Building, Cleveland, OH, 44115, US

(73) Assignee: FLODESIGN WIND TURBINE CORPORATION, Wilbraham, MA (US)

(21) Appl. No.: 12/793,088

(22) Filed: Jun. 3, 2010

Related U.S. Application Data
(63) Continuation-in-part of application No. 12/054,050, filed on Mar. 24, 2008.
(60) Provisional application No. 60/919,588, filed on Mar. 23, 2007.
(60) Provisional application No. 61/183,597, filed on Jun. 3, 2009.

(51) Int. Cl. F03D 1/04; F03D 11/00; B23P 17/00

(52) U.S. Cl. 415/211.2; 415/226; 29/888.025

(57) ABSTRACT

A wind turbine produces a unique pressure profile downstream of the wind turbine. This pressure profile reflects the structure of the wind turbine, which includes a shroud that has mixing lobes on a trailing edge thereof. The pressure profile includes high pressure and low pressure regions corresponding to the number and location of the mixing lobes on the shroud.

This application is a continuation-in-part from U.S. patent application Ser. No. 12/054,050, filed Mar. 24, 2008, which claimed priority from U.S. Provisional Patent Application Ser. No. 60/919,588, filed Mar. 23, 2007. This application also claims priority to U.S. Provisional Patent Application Ser. No. 61/183,597, filed Jun. 3, 2009. Applicants hereby fully incorporate the disclosure of these applications by reference in their entirety.

### BACKGROUND

The present disclosure relates to wind turbines, particularly shrouded wind turbines that produce a unique pressure profile downstream of the wind turbine.

Conventional horizontal axis wind turbines (HAWTs) wind turbines have three blades and are oriented or pointed into the wind by computer controlled motors. These turbines typically require a supporting tower ranging from 60 to 90 meters in height. The blades generally rotate at a rotational speed of about 10 to 22 rpm. A gear box is commonly used to step up the speed to drive the generator, although some designs may directly drive an annular electric generator. Some turbines operate at a constant speed. However, more energy can be collected by using a variable speed turbine and a solid state power converter to interface the turbine with the generator. Although HAWTs have achieved widespread usage, their efficiency is not optimized. In particular, they will not exceed 59.3% efficiency, i.e., the Betz limit, in capturing the potential energy of the wind passing through it.

Several problems are associated with HAWTs in both construction and operation. The tall towers and long blades are difficult to transport. Massive tower construction is required to support the heavy blades, gearbox, and generator. Very tall and expensive cranes and skilled operators are needed for installation. In operation, HAWTs require an additional yaw control mechanism to turn the blades toward the wind. HAWTs typically have a high angle of attack on their airfoils that do not lend themselves to variable changes in wind flow. HAWTs are difficult to operate in near ground, turbulent winds. Furthermore, ice build-up on the nacelle and the blades can cause power reduction and safety issues. Tall HAWTs may affect airport radar. Their height also makes them obtrusively visible across large areas, disrupting the appearance of the landscape, which may be objectionable. Finally, downwind variants suffer from fatigue and structural failure caused by turbulence.

The turbine blade of a HAWT typically has an airfoil shape that creates a lower pressure behind the blade as the blade passes through the air. This lower pressure creates a suction effect that follows the blade and creates a large wake to form behind the HAWT. This wake can reduce the amount of power captured by wind turbines downstream of the wind turbine creating the wake by up to 30%. To reduce the amount of power depletion, downstream turbines are often offset laterally from the upstream turbine, and are placed about 10 rotor diameters downstream of the upstream turbine as well. This displacement requires a large amount of land for a wind farm, where several wind turbines are placed in a single location. It would be desirable to provide a wind turbine that can reduce the amount of displacement required to provide a given power output from another downstream wind turbine.

### BRIEF DESCRIPTION

Disclosed herein are shrouded wind turbines that have a unique pressure profile downstream of the wind turbine. This pressure profile is produced by the unique structure of the wind turbine. In particular, the wind turbine uses a coupled configuration of ringed or annular airfoils and aerodynamic surfaces called mixing lobes to produce more power from the wind.

A mixer/ejector wind turbine system (referenced herein as the “MEWT”) for generating power is disclosed that combines fluid dynamic ejector concepts, advanced flow mixing and control devices, and an adjustable power turbine.

In some embodiments or versions, the MEWT is an axial flow turbine comprising, in order going downstream: an aerodynamically contoured turbine shroud having an inlet; a ring of stators within the shroud; an impeller having a ring of impeller blades “in line” with the stators; a mixer, associated with the turbine shroud, having a ring of mixing lobes extending downstream beyond the impeller blades; and an ejector comprising the ring of mixing lobes and a mixing shroud extending downstream beyond the mixing lobes. The turbine shroud, mixer and ejector are designed and arranged to draw the maximum amount of wind through the turbine and to minimize impact upon the environment (e.g., noise) and upon other power turbines in its wake (e.g., structural or productivity losses). Unlike existing wind turbines, the preferred MEWT contains a shroud with advanced flow mixing and control devices such as lobed or slotted mixers and/or one or more ejector pumps. The mixer/ejector pump presented is much different than used heretofore since in the disclosed wind turbine, the high energy air flows into the ejector inlets, and outwardly surrounds, pumps and mixes with the low energy air exiting the turbine shroud.

In a first embodiment or version, the MEWT comprises: an axial flow turbine surrounded by an aerodynamically contoured turbine shroud incorporating mixing devices in its terminus region (i.e., an end portion of the turbine shroud) and a separate downstream ejector shroud overlapping the aft or downstream edge of the turbine shroud, which itself may incorporate advanced mixing devices in its terminus region.

In an alternate embodiment, the MEWT comprises: an axial flow turbine surrounded by an aerodynamically contoured turbine shroud incorporating mixing devices in its terminus region.

Also disclosed in other embodiments is a turbine comprising: a mixer shroud having an outlet and an inlet for receiving a primary fluid stream; and means for extracting energy from the primary fluid stream, the means for extracting energy being located within the turbine shroud; wherein the mixer shroud includes a set of high energy mixing lobes and a set of low energy mixing lobes; wherein each high energy mixing lobe forms an angle in the range of about of 5 to 65 degrees relative to the mixer shroud; and wherein each low energy mixing lobe forms an angle in the range of about 5 to 65 degrees relative to the mixer shroud or the turbine axis.

The high energy mixing lobe angle may be different from, greater than, less than, or equal to the low energy mixing lobe angle.

The turbine may further comprise an ejector shroud downstream from and coaxial with the mixer shroud, wherein a mixer shroud outlet extends into an ejector shroud inlet. The ejector shroud may itself have a ring of mixer lobes around its outlet.

The means for extracting energy may be an impeller or a rotor/stator assembly.

Also disclosed is a turbine comprising: a mixer shroud having an inlet for receiving a primary fluid stream and an outlet; and means for extracting energy from the primary fluid stream, the means for extracting energy being located within the turbine shroud; wherein the mixer shroud includes a set of mixing lobes, each mixing lobe having an inner trailing edge angle and an outer trailing edge angle; wherein the inner trailing edge angle is from 5 to 65 degrees and the outer trailing edge angle is from 5 to 65 degrees with respect to the turbine axis with respect to the mixer shroud or the turbine axis.

First-principles-based theoretical analysis of the preferred MEWT indicates that the MEWT can produce three or more times the power of its un-shrouded counterparts for the same frontal area, and increase the productivity, in the case of wind turbines, of wind farms by a factor of two or more.

Also disclosed are methods of extracting additional energy or generating additional power from a fluid stream. The methods comprise providing a mixer shroud that divides incoming fluid into two fluid streams, one inside the mixer shroud and one outside the mixer shroud. Energy is extracted from the fluid stream passing inside the mixer shroud and through a turbine stage, resulting in a reduced-energy fluid stream exiting the turbine stage. The reduced-energy fluid stream is then mixed with the outside fluid stream, to form a series of vortices that mixes the two fluid streams and causes a lower-pressure area to form downstream of the mixer shroud. This lower pressure area in turn causes additional fluid to flow through the turbine stage.

Disclosed in embodiments is a wind turbine that produces a fluid pressure profile downstream of the turbine in an exit plane, the pressure profile comprising: a first low pressure region defining a center of the pressure profile; a first high pressure region surrounding the first low pressure region; and a first mixed pressure ring surrounding the first high pressure region, the mixed pressure ring comprising a plurality of high pressure pockets and a plurality of low pressure pockets, the high pressure pockets and the low pressure pockets alternating around the mixed pressure ring.

The pressure profile may further comprises a second pressure ring surrounding the first mixed pressure ring, wherein the second pressure ring comprises a plurality of high pressure pockets, each high pressure pocket being aligned along a radius with a low pressure pocket in the first mixed pressure ring. The second pressure ring high pressure pockets may have a pressure of at least 0 psig.

The pressure profile may further comprise a high pressure line surrounding the first mixed pressure ring and the second pressure ring, the high pressure line having a circular crenellated shape. The high pressure line may have a pressure of at least 0 psig.

The pressure profile may further comprise a set of high pressure spots surrounding the high pressure line.

The pressure profile may further comprise high pressure gaps between the high pressure line and the high pressure spots, the high pressure gaps having a greater pressure than the high pressure line and the high pressure spots

The first low pressure region may have a pressure below 0 psig. The first low pressure region may have a pressure from at least minus 1 psig to less than 0 psig. The first high pressure region may have a pressure of at least 0 psig. The first high pressure region may have a pressure from 0 psig to 0.054 psig. The high pressure pockets in the first mixed pressure ring may have a pressure of at least 0 psig. The high pressure pockets in the first mixed pressure ring may have a pressure from 0 psig to 0.054 psig. The low pressure pockets in the first mixed pressure ring may have a pressure from at least minus 1 psig to less than 0 psig.

Also disclosed is a wind turbine that produces a fluid pressure profile downstream of the turbine in an exit plane, the pressure profile comprising: a first low pressure region defining a center of the pressure profile; a first high pressure region surrounding the first low pressure region; a first mixed fluid pressure ring surrounding the first high pressure region, the mixed pressure ring comprising a plurality of high pressure pockets and a plurality of low pressure pockets, the high pressure pockets and the low pressure pockets alternating around the mixed pressure ring; a second fluid pressure ring surrounding the first mixed pressure ring, wherein the second pressure ring comprises a plurality of high pressure pockets, each high pressure pocket being aligned along a radius with a low pressure pocket in the first mixed pressure ring; and a high pressure line surrounding the first mixed pressure ring and the second pressure ring, the high pressure line having a circular crenellated shape.

Also disclosed is a method of making a wind turbine comprising: (a) providing an impeller that rotates about a horizontal axis; (b) surrounding the impeller with a turbine shroud, the shroud having an airfoil cross-section shape and reducing the pressure of the wind stream passing through the impeller; (c) disposing an ejector shroud co-axially with and downstream of the turbine shroud; and (d) forming a plurality of spaced radially inwardly extending mixing lobes and a plurality of radially outwardly extending mixing lobes on a downstream edge of the turbine shroud, the inwardly extending mixing lobes alternating with the outwardly extending mixing lobes about the downstream edge.

The step of forming inwardly extending lobes and outwardly extending lobes may include crenellating the downstream edge of the turbine shroud.

The step of surrounding the impeller with a turbine shroud may include forming a skeleton from a rigid material and covering at least a portion of the skeleton with a skin, the skin comprising a fabric or a polymer film. The skin can have multiple layers.

The step of disposing an ejector shroud may include forming an ejector shroud skeleton from a rigid material and covering at least a portion of the ejector shroud skeleton with a skin, the skin comprising a fabric or a polymer film. The skin can have multiple layers.

The impeller may be a rotor/stator assembly. The inwardly extending mixing lobes and the outwardly extending mixing lobes can be independently formed to make an angle of from 5 to 65 degrees relative to the horizontal axis.

These and other non-limiting features or characteristics of the present disclosure will be further described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the disclosure set forth herein and not for the purposes of limiting the same.

FIG. 1 is an exploded view of a first exemplary embodiment or version of a MEWT of the present disclosure.

FIG. 2 is a front perspective view of FIG. 1 attached to a support tower.

FIG. 3 is a front perspective view of a second exemplary embodiment of a MEWT, shown with a shrouded three bladed impeller.

FIG. 4 is a rear perspective view of the MEWT of FIG. 3.

FIG. 5 shows a rear view of the MEWT of FIG. 3.

FIG. 6 is a cross-sectional view taken along line 6-6 of FIG. 5.

FIG. 7 is a front view of the MEWT of FIG. 3.

FIG. 8 is a cross-sectional view, taken along line 8-8 of FIG. 7, showing two pivotable blockers for flow control.

FIG. 9 is an enlarged view of a pivotable blocker of FIG. 8.

FIG. 10 is a perspective view of partially completed skeletons of a turbine shroud and an ejector shroud for an exemplary wind turbine of the present disclosure.

FIG. 11 is a perspective view of the partially completed turbine shroud skeleton of FIG. 10.

FIG. 12 is a perspective view of the partially completed ejector shroud skeleton of FIG. 10.

FIG. 13 is a perspective view showing the skeletons of FIG. 10 in a completed form.

FIG. 14 is a perspective view of the skeletons of FIG. 13 with a portion of the covering skin attached to the exterior of the turbine shroud and the ejector shroud.

FIG. 15 is a perspective view of another exemplary embodiment of a wind turbine of the present disclosure having a pair of wing-tabs for wind alignment.

FIG. 16 is a diagram illustrating the flow of slower air through a mixer shroud.

FIG. 17 is a diagram illustrating the flow of faster air around a mixer shroud.

FIG. 18 is a diagram illustrating the meeting of a faster air stream and a slower air stream.

FIG. 19 is a diagram illustrating a vortex formed by the meeting of a faster air stream and a slower air stream.

FIG. 20 is a diagram illustrating a series of vortices formed by a mixer shroud.

FIG. 21 is a cross-sectional schematic diagram of a mixer shroud.

FIG. 22 is a front perspective view of another exemplary embodiment of a MEWT according to the present disclosure.

FIG. 23 is a side cross-sectional view of the MEWT of FIG. 22 taken through the turbine axis.

FIG. 24 is a smaller view of FIG. 23.

FIG. 24A and FIG. 24B are magnified views of the mixing lobes of the MEWT of FIG. 24.

FIG. 25 is a side cross-sectional view of a wind turbine.

FIG. 26 is a pressure profile of the wind turbine of FIG. 25.

FIG. 27 is a half view of a wind turbine from a position downstream looking upstream (i.e. a rear view).

FIG. 28 is a pressure profile of the wind turbine of FIG. 27.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate the relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range from about 2 to about 4″ also discloses the range “from 2 to 4.”

A Mixer-Ejector Power System (MEPS) provides a unique and improved means of generating power from wind currents. A MEPS includes:
a primary shroud containing a turbine or bladed impeller, similar to a propeller, which extracts power from the primary stream; and
a single or multiple-stage mixer-ejector to ingest flow with each such mixer/ejector stage including a mixing duct for both bringing in secondary flow and providing flow mixing-length for the ejector stage. The inlet contours of the mixing duct or shroud are designed to minimize flow losses while providing the pressure forces necessary for good ejector performance.

The resulting mixer/ejectors enhance the operational characteristics of the power system by: (a) increasing the amount of flow through the system, (b) reducing the exit or back pressure on the turbine blades, and (c) reducing the noise propagating from the system.

The MEPS may include:
camber to the duct profiles to enhance the amount of flow into and through the system;
acoustical treatment in the primary and mixing ducts for noise abatement flow guide vanes in the primary duct for control of flow swirl and/or mixer-lobes tailored to diminish flow swirl effects;
turbine-like blade aerodynamics designs based on the new theoretical power limits to develop families of short, structurally robust configurations which may have multiple and/or counter-rotating rows of blades;
exit diffusers or nozzles on the mixing duct to further improve performance of the overall system;
inlet and outlet areas that are non-circular in cross section to accommodate installation limitations;
a swivel joint on its lower outer surface for mounting on a vertical stand/pylon allowing for turning the system into the wind;
vertical aerodynamic stabilizer vanes mounted on the exterior of the ducts with tabs or vanes to keep the system pointed into the wind; or
mixer lobes on a single stage of a multi-stage ejector system.

Referring to the drawings in detail, the figures illustrate alternate embodiments of Applicants' axial flow Wind Turbine with Mixers and Ejectors (“MEWT”).

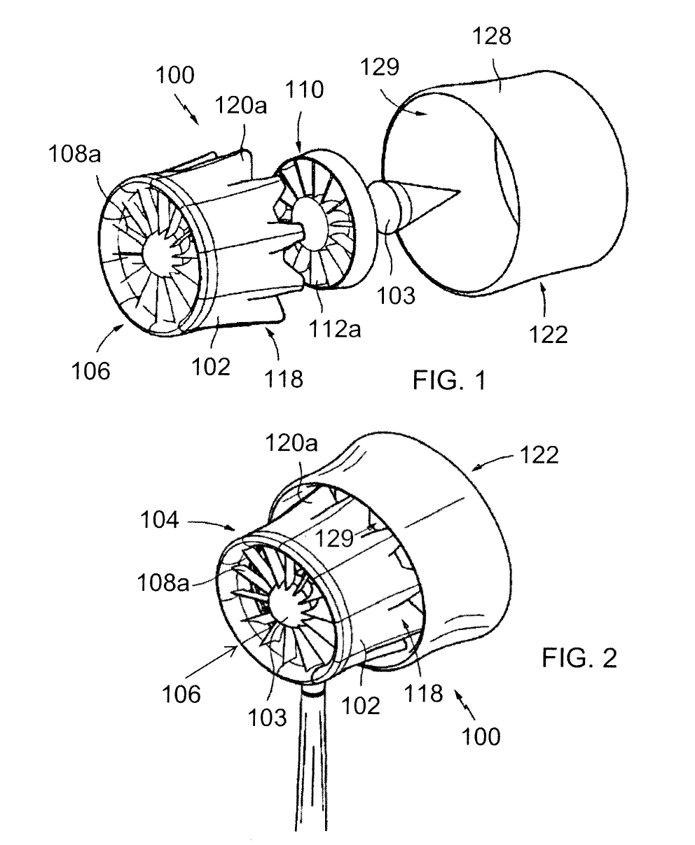

Referring to FIG. 1 and FIG. 2, the MEWT 100 is an axial flow turbine with:

a) an aerodynamically contoured turbine shroud 102;

b) an aerodynamically contoured center body 103 within and attached to the turbine shroud 102;

c) a turbine stage 104, surrounding the center body 103, comprising a stator ring 106 having stator vanes 108a and a rotor 110 having rotor blades 112a. Rotor 110 is downstream and “in-line” with the stator vanes, i.e., the leading edges of the impeller blades are substantially aligned with trailing edges of the stator vanes, in which:
i) the stator vanes 108a are mounted on the center body 103;
ii) the rotor blades 112a are attached and held together by inner and outer rings or hoops mounted on the center body 103;

d) a mixer indicated generally at 118 having a ring of mixer lobes 120a on a terminus region (i.e., end portion) of the turbine shroud 102, wherein the mixer lobes 120a extend downstream beyond the rotor blades 112a; and,

e) an ejector indicated generally at 122 comprising an ejector shroud 128, surrounding the ring of mixer lobes 120a on the turbine shroud, wherein the mixer lobes (e.g., 120a) extend downstream and into an inlet 129 of the ejector shroud 128.

The center body 103 of MEWT 100, as shown in FIG. 2, is desirably connected to the turbine shroud 102 through the stator ring 106, or other means. This construction serves to eliminate the damaging, annoying and long distance propagating low-frequency sound produced by traditional wind turbines as the wake from the turbine blades strike the support tower. The aerodynamic profiles of the turbine shroud 102 and ejector shroud 128 are aerodynamically cambered to increase flow through the turbine rotor.

Applicants have calculated, for optimum efficiency, the area ratio of the ejector pump 122, as defined by the ejector shroud 128 exit area over the turbine shroud 102 exit area, will be in the range of 1.5-4.0. The number of mixer lobes 120a would be between 6 and 14. Each lobe will have inner and outer trailing edge angles between 5 and 65 degrees. These angles are measured from a tangent line that is drawn at the exit of the mixing lobe down to a line that is parallel to the center axis of the turbine, as will be explained further herein. The primary lobe exit location will be at, or near, the entrance location or inlet 129 of the ejector shroud 128. The height-to-width ratio of the lobe channels will be between 0.5 and 4.5. The mixer penetration will be between 50% and 80%. The center body 103 plug trailing edge angles will be thirty degrees or less. The length to diameter (L/D) of the overall MEWT 100 will be between 0.5 and 1.25.

First-principles-based theoretical analysis of the preferred MEWT 100, performed by Applicants, indicate the MEWT can produce three or more times the power of its un-shrouded counterparts for the same frontal area; and, the MEWT 100 can increase the productivity of wind farms by a factor of two or more. Based on this theoretical analysis, it is believed the MEWT embodiment 100 will generate three times the existing power of the same size conventional open blade wind turbine.

A satisfactory embodiment 100 of the MEWT comprises: an axial flow turbine (e.g., stator vanes and impeller blades) surrounded by an aerodynamically contoured turbine shroud 102 incorporating mixing devices in its terminus region (i.e., end portion); and a separate ejector shroud 128 overlapping, but aft, of turbine shroud 102, which itself may incorporate mixer lobes in its terminus region. The ring 118 of mixer lobes 120a combined with the ejector shroud 128 can be thought of as a mixer/ejector pump. This mixer/ejector pump provides the means for consistently exceeding the Betz limit for operational efficiency of the wind turbine. The stator vanes' exit-angle incidence may be mechanically varied in situ (i.e., the vanes are pivoted) to accommodate variations in the fluid stream velocity so as to assure minimum residual swirl in the flow exiting the rotor.

Described differently, the MEWT 100 comprises a turbine stage 104 with a stator ring 106 and a rotor 110 mounted on center body 103, surrounded by turbine shroud 102 with embedded mixer lobes 120a having trailing edges inserted slightly in the entrance plane of ejector shroud 128. The turbine stage 104 and ejector shroud 128 are structurally connected to the turbine shroud 102, which is the principal load carrying member.

These figures depict a rotor/stator assembly for generating power. The term “impeller” is used herein to refer generally to any assembly in which blades are attached to a shaft and able to rotate, allowing for the generation of power or energy from wind rotating the blades. Exemplary impellers include a propeller or a rotor/stator assembly. Any type of impeller may be enclosed within the turbine shroud 102 in the wind turbine of the present disclosure.

In some embodiments, the length of the turbine shroud 102 is equal or less than the turbine shroud's outer maximum diameter. Also, the length of the ejector shroud 128 is equal or less than the ejector shroud's outer maximum diameter. The exterior surface of the center body 103 is aerodynamically contoured to minimize the effects of flow separation downstream of the MEWT 100. It may be configured to be longer or shorter than the turbine shroud 102 or the ejector shroud 128, or their combined lengths.

The turbine shroud's entrance area and exit area will be equal to or greater than that of the annulus occupied by the turbine stage 104, but need not be circular in shape so as to allow better control of the flow source and impact of its wake. The internal flow path cross-sectional area formed by the annulus between the center body 103 and the interior surface of the turbine shroud 102 is aerodynamically shaped to have a minimum area at the plane of the turbine and to otherwise vary smoothly from their respective entrance planes to their exit planes. The turbine and ejector shrouds' external surfaces are aerodynamically shaped to assist guiding the flow into the turbine shroud inlet, eliminating flow separation from their surfaces, and delivering smooth flow into the ejector entrance 129. The ejector 128 entrance area, which may alternatively be noncircular in shape, is greater than the mixer 118 exit plane area; and the ejector's exit area may also be noncircular in shape if desired.

Optional features of the preferred embodiment 100 can include: a power take-off, in the form of a wheel-like structure, which is mechanically linked at an outer rim of the impeller to a power generator; a vertical support shaft with a rotatable coupling for rotatably supporting the MEWT, the shaft being located forward of the center-of-pressure location on the MEWT for self-aligning the MEWT; and a self-moving vertical stabilizer fin or “wing-tab” affixed to upper and lower surfaces of the ejector shroud to stabilize alignment directions with different wind streams.

The MEWT 100, when used near residences can have sound absorbing material affixed to the inner surface of its shrouds 102, 128 to absorb and thus eliminate the relatively high frequency sound waves produced by the interaction of the stator 106 wakes with the rotor 110. The MEWT 100 can also contain blade containment structures for added safety.

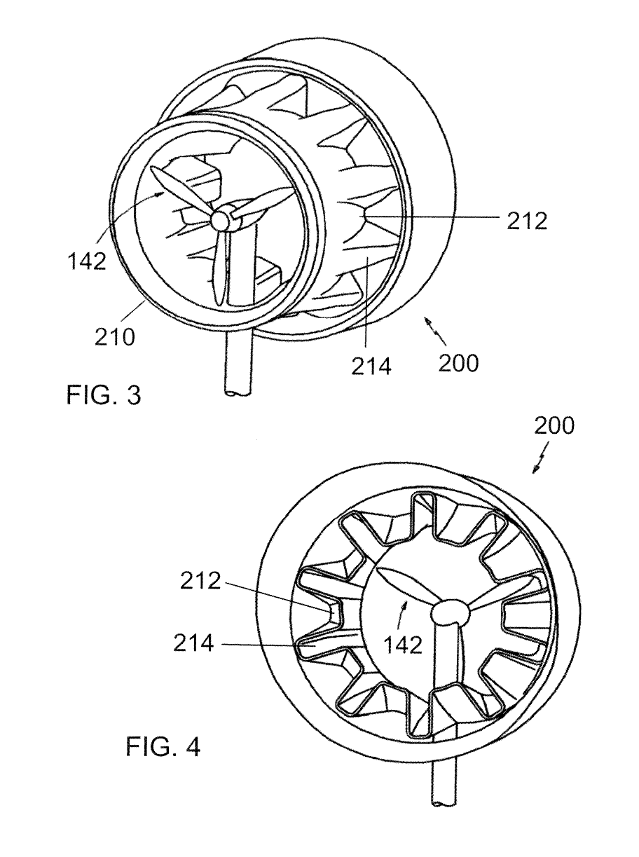

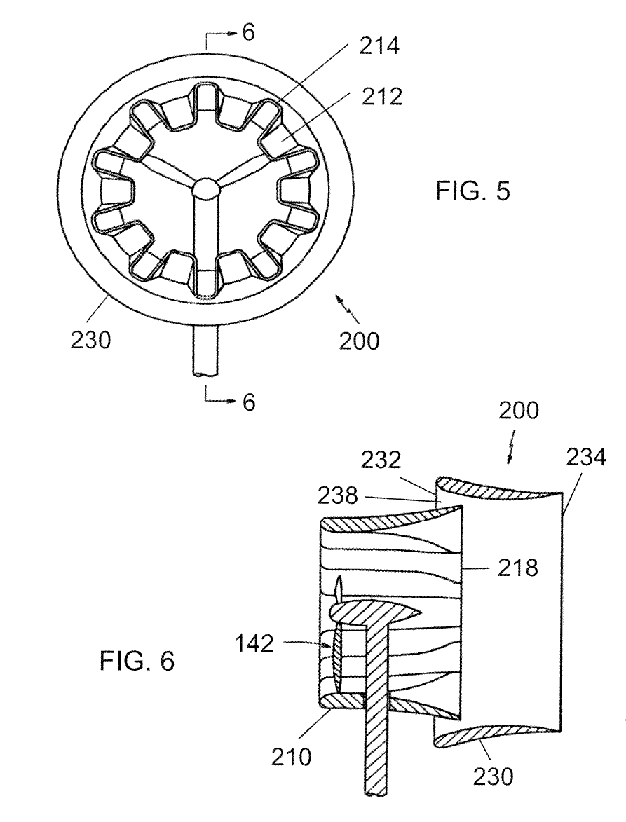

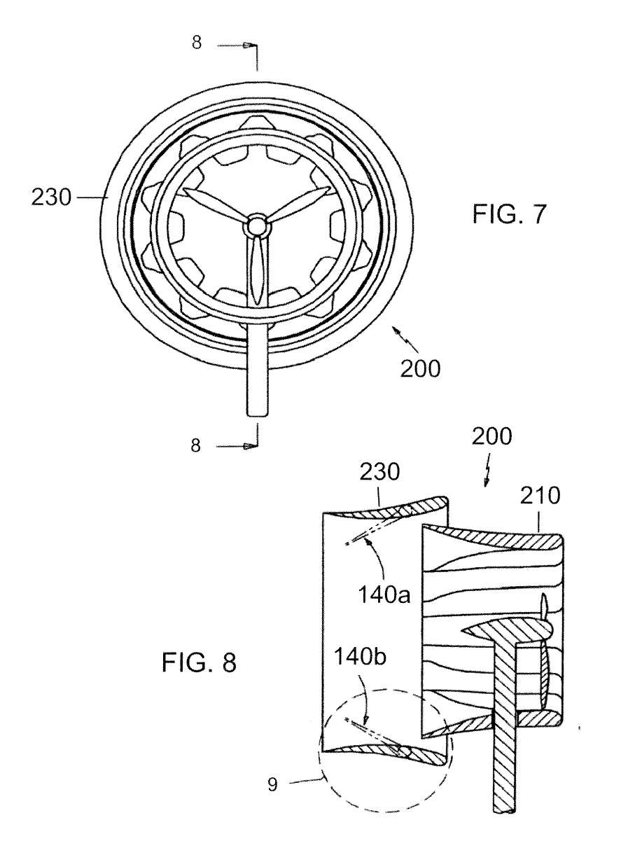

FIGS. 3-8 show a second exemplary embodiment of a shrouded wind turbine 200. The turbine 200 uses a propeller-type impeller 142 instead of the rotor/stator assembly as in FIG. 1 and FIG. 2. In addition, the mixing lobes can be more clearly seen in this embodiment. The turbine shroud 210 has two different sets of mixing lobes. Referring to FIG. 4 and FIG. 5, the turbine shroud 210 has a set of high energy mixing lobes 212 that extend inwards toward the central axis of the turbine. In this embodiment, the turbine shroud is shown as having 10 high energy mixing lobes. The turbine shroud also has a set of low energy mixing lobes 214 that extend outwards away from the central axis. Again, the turbine shroud 210 has 10 low energy mixing lobes. The high energy mixing lobes alternate with the low energy mixing lobes around the trailing edge of the turbine shroud 210.

As seen in FIG. 6, the entrance area 232 of the ejector shroud 230 is larger than the exit area 234 of the ejector shroud. It will be understood that the entrance area refers to the entire mouth of the ejector shroud and not the annular area of the ejector shroud between the ejector shroud 230 and the turbine shroud 210. However, as seen further herein, the entrance area of the ejector shroud may also be smaller than the exit area 234 of the ejector shroud. As expected, the entrance area 232 of the ejector shroud 230 is larger than the exit area 218 of the turbine shroud 210, in order to accommodate the mixing lobes and to create an annular area 238 between the turbine shroud and the ejector shroud through which high energy air can enter the ejector.

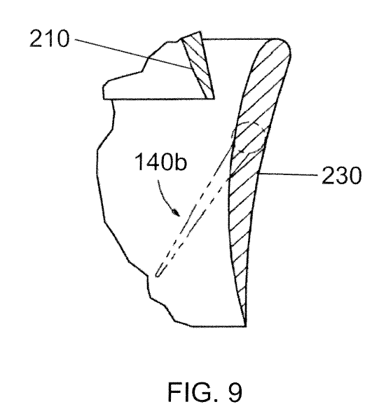

FIG. 8 and FIG. 9 show optional flow blockage doors 140a or flaps 140b which may be added to the version 200. The doors can be rotated via linkage and actuator (not shown) into the flow stream to reduce or stop flow through the turbine 200 when damage, to the generator or other components, due to high flow velocity is possible.

The mixer-ejector design concepts described herein can significantly enhance fluid dynamic performance. These mixer-ejector systems provide numerous advantages over conventional systems, such as: shorter ejector lengths; increased mass flow into and through the system; lower sensitivity to inlet flow blockage and/or misalignment with the principal flow direction; reduced aerodynamic noise; added thrust; and increased suction pressure at the primary exit.

A MEWT with a portion of its structure comprised of a rigid frame covered by a flexible stretched fabric or thin membrane provides significant benefits over conventional wind turbines. The combination of the lightweight frame and soft structure requires less substantial supports for the turbine body due to the decrease in weight. The soft shell component provides ease of manufacturability and replacement. The flexible fabric or thin membrane can also flex, causing ice to lose contact and break away from the surface. Generally speaking, the turbine shroud and/or ejector shroud can first be formed, then placed or disposed around the impeller, or can be constructed around the impeller.

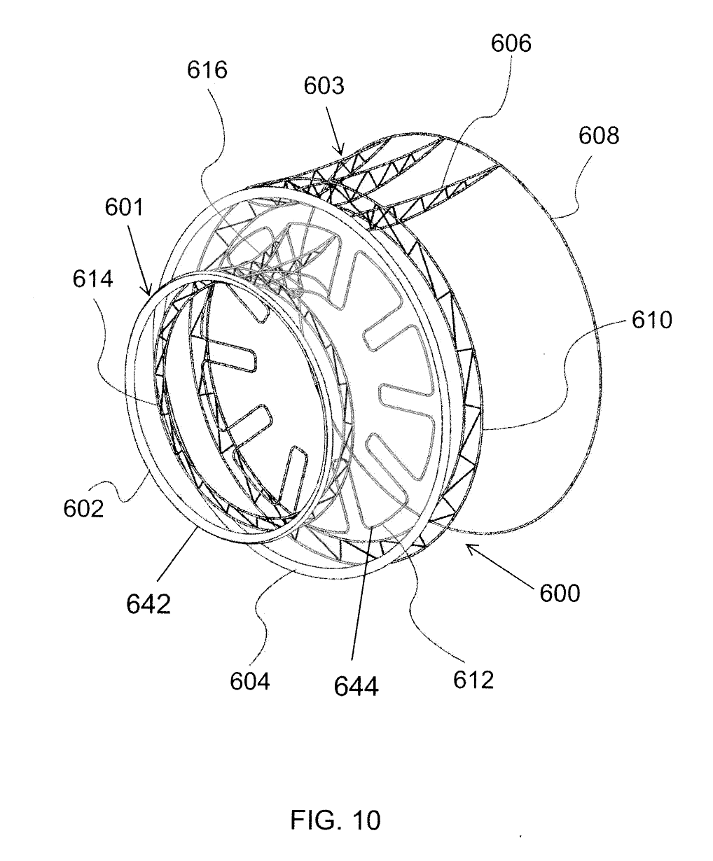

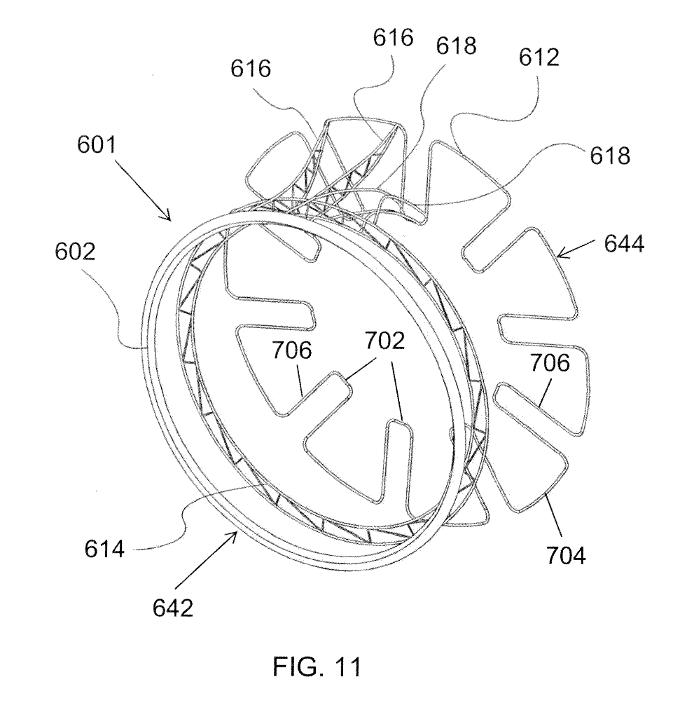

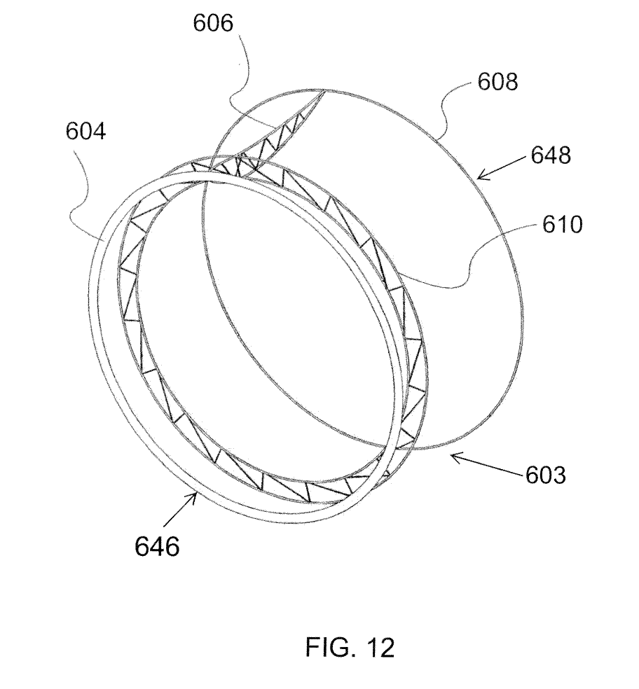

FIGS. 10-14 illustrate an embodiment or version of a wind turbine indicated generally at 600 having a turbine shroud and an ejector shroud constructed in the following manner. Each shroud can be considered as having a skeleton-and-skin structure. FIG. 10 shows both the turbine shroud skeleton 601 and the ejector shroud skeleton 603 in their partially completed state. FIG. 11 shows only the turbine shroud skeleton 601 in a partially completed state. FIG. 12 shows only the ejector shroud skeleton 603 in a partially completed state.

Referring now to FIG. 11, the turbine shroud skeleton 601 includes a turbine shroud front ring structure or first rigid structural member 602, a turbine shroud mixing structure or second rigid structural member 612, and a plurality of first internal ribs 616. A turbine shroud ring truss 614 may be included to further define the shape of the turbine shroud, as well as provide a connecting point between the turbine shroud skeleton 601 and the ejector shroud skeleton 603. When present, the ring truss 614 is substantially parallel to the turbine shroud front ring structure 602 and normal to the turbine axis. A plurality of second internal ribs 618 may also be used to further define the shape of the mixing lobes. Generally, the first internal ribs 616 and second internal ribs 618 have different shapes from each other. The first rigid structural member 602, ring truss 614, and second rigid structural member 612 are all connected to each other through the first internal ribs 616 and the second internal ribs 618. The first rigid structural member 602 and the second rigid structural member 612 are generally parallel to each other and normal to the turbine axis.

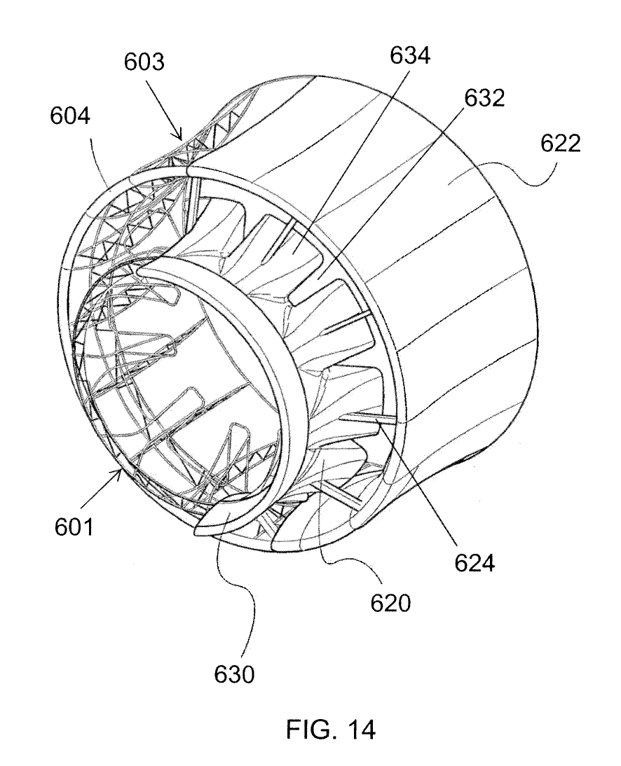

The turbine shroud first rigid structural member 602 defines a front or inlet end of the turbine shroud skeleton 601. The turbine shroud first rigid structural member 602 also defines a leading edge 642 of the turbine shroud. The turbine shroud second rigid structural member 612 defines a rear end, exit end, or exhaust end of the turbine shroud skeleton 601, and also defines a trailing edge 644, with the mixing lobes 632, 634 (see FIG. 14) placed around the circumference of the trailing edge. The first rigid structural member 612 provides a structure to support the impeller and also acts as a funnel to channel air through the impeller.

The second rigid structural member 612 is shaped somewhat like a gear with a circular crenellated or castellated shape. The second rigid structural member 612 can be considered as being formed from several inner circumferentially spaced arcuate portions 702 which each have the same radius of curvature. Those inner arcuate portions are preferably evenly spaced apart from each other. In those spaces between portions 702 are several outer arcuate portions 704, which each have the same radius of curvature. The radius of curvature for the inner arcuate portions is different from the radius of curvature for the outer arcuate portions 704, but the inner arcuate portions and outer arcuate portions should share generally the same center. The inner portions 702 and the outer arcuate portions 704 are then connected to each other by radially extending portions 706. This results in a circular crenellated shape. The term “crenellated” or “castellated” are not used herein as requiring the inner arcuate portions, outer arcuate portions, and radially extending portions to be straight lines, but rather to refer to the general up-and-down or in-and-out shape of the second rigid structural member 612. The first internal ribs 616 connect to the second rigid structural member 612 along the outer arcuate portions 704, while the second internal ribs 618 connect to the second rigid structural member 612 along the inner arcuate portions 704. As will be explained further herein, this structure forms two sets of mixing lobes, high energy mixing lobes and low energy mixing lobes. It should be noted that the crenellated shape may be only part of the second rigid structural member, and that the second rigid structural member could be shaped differently further upstream of the crenellated shape.

Referring now to FIG. 12, the ejector shroud sub-skeleton 603 includes an ejector shroud front ring structure or first rigid structural member 604, a plurality of first internal ribs 606, and a second rigid structural member 608. Again, an ejector shroud ring 610, which may be formed as a truss, may be included to further define the shape of the ejector shroud, and provide a connecting point between the turbine shroud sub-skeleton 601 and the ejector shroud sub-skeleton 603. When present, the ring truss 610 is substantially parallel to the ejector shroud front ring structure 604 and disposed normal to the turbine axis. The first rigid structural member 604, ring truss 610, and second rigid structural member 608 are all connected to each other through the plurality of first internal ribs 606, only one of which is shown in FIG. 12. The first rigid structural member 604 and the second rigid structural member 608 are generally parallel to each other and normal to the turbine axis.

The ejector shroud front ring structure 604 defines a front or inlet end 605 of the ejector shroud sub-skeleton 603. The ejector shroud rear ring structure 608 defines a rear end, exit end, or exhaust end 607 of the ejector shroud sub-skeleton 603. The exhaust end 607 of the ejector shroud rear ring structure 608 also defines a rear end, exit end, or exhaust end of the overall skeleton 600. The ejector shroud front ring structure 604 defines a leading edge of the ejector shroud. Both the first rigid structural member 604 and the second rigid structural member 608 are substantially circular.

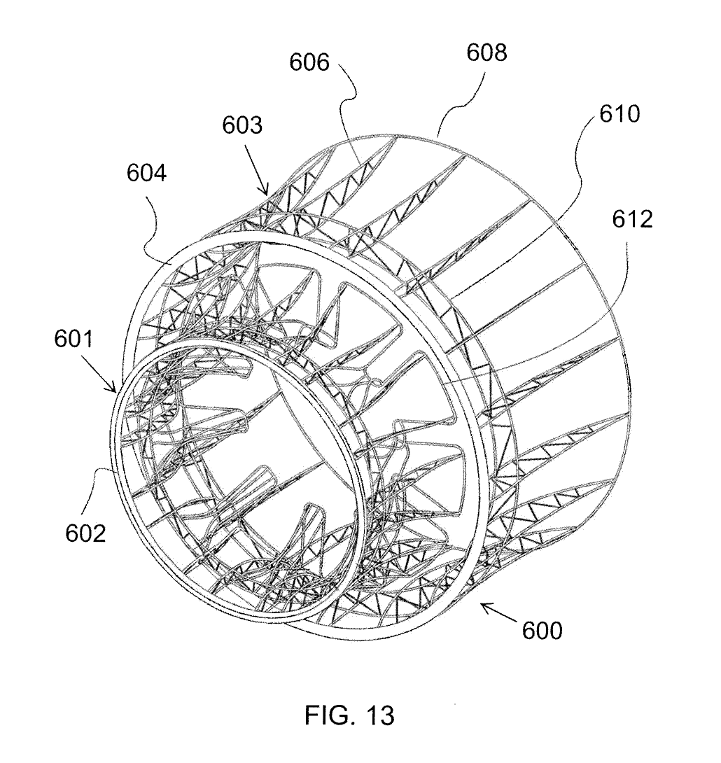

FIG. 13 shows both skeletons in an assembled state, without the skins on either shroud.

FIG. 14 illustrates the skeletons with the skin partially applied. A turbine skin 620 partially covers the turbine shroud skeleton 601, while an ejector skin 622 partially covers the ejector shroud skeleton 603. Support members 624 are also shown that connect the turbine shroud skeleton 601 to the ejector shroud skeleton 603. The support trusses 624 are connected at their radially inner ends to the turbine shroud ring truss 614 and at their radially outer ends to the ejector shroud ring truss 610. The resulting turbine shroud 630 has two sets of mixing lobes, high energy mixing lobes 632 that extend inwardly toward the central axis of the turbine, and low energy mixing lobes 634 that extend outwardly away from the central axis.

It should be noted that the turbine shroud rigid members 602, 612 are considered “rigid” relative to the skin 620, and could be considered flexible when compared to other materials. Similarly, the ejector shroud rigid members 604, 608 are considered “rigid” relative to the skin 622, and could be considered flexible when compared to other materials. In embodiments, the ribs and structural members of each shroud are made of different materials than the skin of that shroud.

The skin of both the turbine shroud and the ejector shroud may be generally formed of any polymeric or fabric material. Exemplary materials include polyurethane, polyfluoropolymers, and multi-layer films of similar composition. Stretchable fabrics, such as spandex-type fabrics or polyurethane-polyurea copolymer containing fabrics, may also be employed.

Polyurethane films are tough and have good weatherability. The polyester-type polyurethane films tend to be more sensitive to hydrophilic degradation than polyether-type polyurethane films. Aliphatic versions of these polyurethane films are generally ultraviolet resistant as well.

Exemplary polyfluoropolymers include polyvinyldidene fluoride (PVDF) and polyvinyl fluoride (PVF). Commercial versions are available under the trade names KYNAR® and TEDLAR®. Polyfluoropolymers generally have very low surface energy, which allow their surface to remain somewhat free of dirt and debris, as well as shed ice more readily as compared to materials having a higher surface energy.

The skin may be reinforced with a reinforcing material. Examples of reinforcing materials include but are not limited to highly crystalline polyethylene fibers, paramid fibers, and polyaramides.

The turbine shroud skin and ejector shroud skin may independently be multi-layer, comprising one, two, three, or more layers. Multi-layer constructions may add strength, water resistance, UV stability, and other functionality. However, multi-layer constructions may also be more expensive and add weight to the overall wind turbine.

The skin may cover all or part of the skeleton; however, the skin is not required to cover the entire skeleton. For example, the turbine shroud skin may not cover the leading and/or trailing edges of the turbine shroud skeleton. The leading and/or trailing edges of either shroud skeleton may be comprised of rigid materials. Rigid materials include, but are not limited to, polymers, metals, and mixtures thereof. In some embodiments, the rigid materials are glass reinforced polymers. Rigid surface areas around fluid inlets and outlets may improve the aerodynamic properties of the shrouds. The rigid surface areas may be in the form of panels or other constructions.

Film/fabric composites are also contemplated along with a backing, such as, for example, foam backing material.

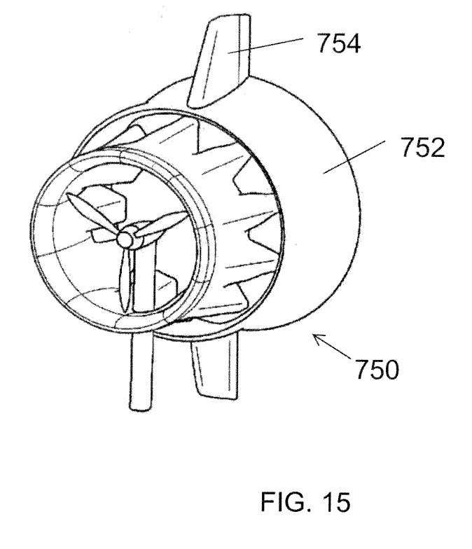

As shown in FIG. 15, another exemplary embodiment of a wind turbine 750 may have an ejector shroud 752 that has internal ribs shaped to provide wing-tabs or fins 754. The wing-tabs or fins 754 are oriented to facilitate alignment of the wind turbine 750 with the incoming wind flow to improve energy or power production.

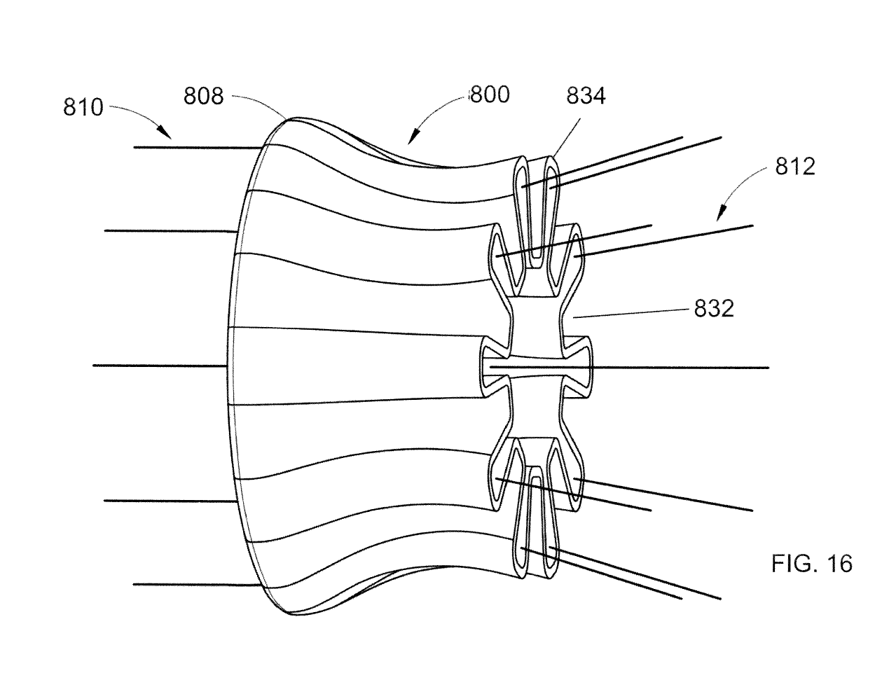

The methods by which energy or power is produced, or by which the energy or power of a fluid turbine is increased, or by which additional amounts of energy are extracted from a fluid stream, are illustrated in FIGS. 16-21. Generally, the wind turbine has a means for defining both (a) a primary fluid stream passing through the turbine and (b) a secondary fluid stream bypassing the turbine. The turbine also has a means for extracting energy from the primary fluid stream. The turbine is placed in contact with a fluid stream, such as free stream wind, to define the primary fluid stream and the secondary fluid stream. Energy is extracted from the primary fluid stream to form a reduced-energy fluid stream. The reduced-energy fluid stream is then mixed with the secondary fluid stream to transfer energy from the secondary fluid stream to the reduced-energy fluid stream. This mixing causes additional fluid to join the primary fluid stream, enhancing the flow volume through the turbine and increasing the amount of energy extracted. A reduced-pressure area also results from the mixing of the two fluid streams.

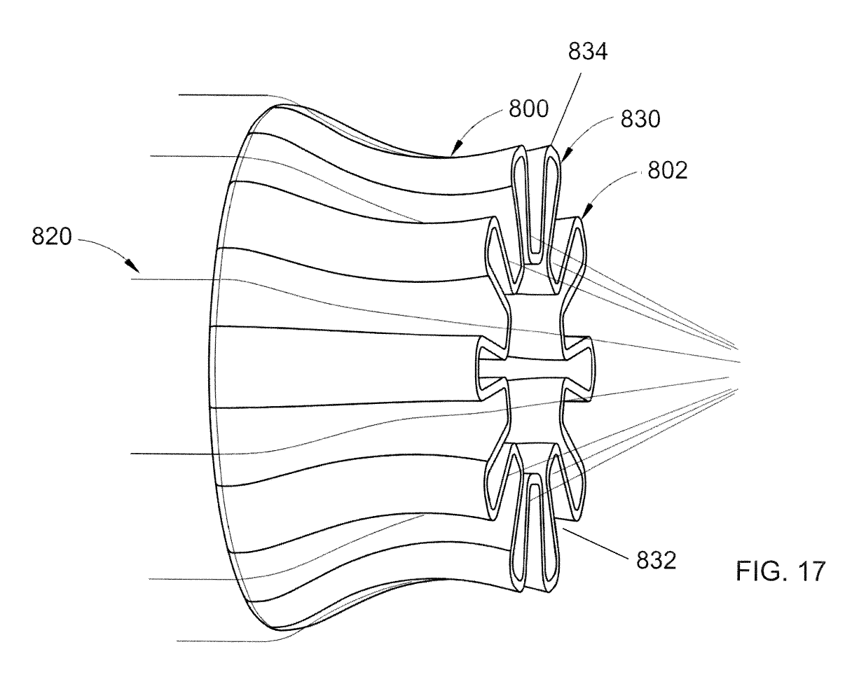

As shown in FIG. 16 and FIG. 17, a mixer shroud 800 surrounds a power extraction unit, such as a turbine stage (not shown). The mixer shroud 800 separates the incoming wind into a first fluid stream 810 that passes inside the mixer shroud and through the power extraction unit (not shown), and a second fluid stream 820 that passes outside the mixer shroud and bypasses the power extraction unit. The mixer shroud 800 has an outlet or exit end 802. A plurality of mixer lobes 830 is disposed around this outlet 802. The mixer lobes can be separated into two sets, a set of high energy mixing lobes 832 and a set of low energy mixing lobes 834. The high energy mixing lobes 832 extend inwardly toward the central axis of the turbine. The low energy mixing lobes 834 extend outwardly away from the central axis. The high energy mixing lobes alternate with the low energy mixing lobes around the downstream or trailing edge of the mixer shroud 800. The mixer shroud 800 also has a flared inlet 808. Mixer shroud 800 corresponds to the means for defining a primary fluid stream and a secondary fluid stream discussed above. After passing through the power extraction unit, the primary fluid stream becomes reduced-energy fluid stream 812 which exits at the outlet 802.

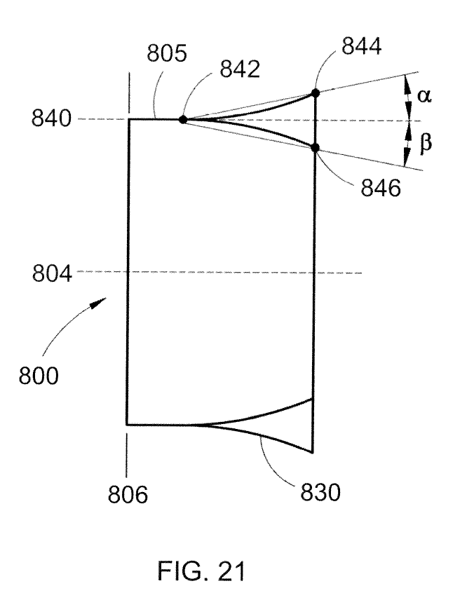

Referring to the cross-sectional view of FIG. 21, each mixer lobe 830 has an outer trailing edge angle α and an inner trailing edge angle β. The mixer shroud 800 has a central axis 804. The angles α and β are measured relative to a plane 840 which is parallel to the central axis, perpendicular to the entrance plane 806 of the mixer shroud, and along the surface 805 of the mixer shroud. The angle is measured from the vertex point 842 at which the mixer shroud begins to diverge to form the mixer lobes. The outer trailing edge angle α is measured at the outermost point 844 on the trailing edge of the mixer lobe, while the inner trailing edge angle β is measured at the innermost point 846 on the trailing edge of the mixer lobe. In some embodiments, outer trailing edge angle α and inner trailing edge angle β are different, and in others α and β are equal. In particular embodiments, inner trailing edge angle β is greater than or less than outer trailing edge angle α. As mentioned previously, each angle can be independently in the range of 5 to 65 degrees.

Referring to FIG. 16, the turbine stage then extracts energy from the primary fluid stream to generate or produce energy or power. After passing through the turbine stage, the primary fluid stream can also be considered a post-turbine primary fluid stream or a reduced-energy fluid stream 812, in that it contains less energy than before entering the turbine stage. The shape of mixer shroud 800 causes primary fluid stream 810 to flare outwardly (i.e. through the low-energy mixing lobes 834) after passing through the turbine. Put another way, mixer shroud 800 directs reduced-energy fluid stream 812 away from central axis 804.

Referring to FIG. 17, the shape of mixer shroud 800 causes secondary fluid stream 820 to flow inwardly through the high-energy mixing lobes 832. Mixer shroud 800 thus directs the secondary fluid stream 820 toward central axis 804.

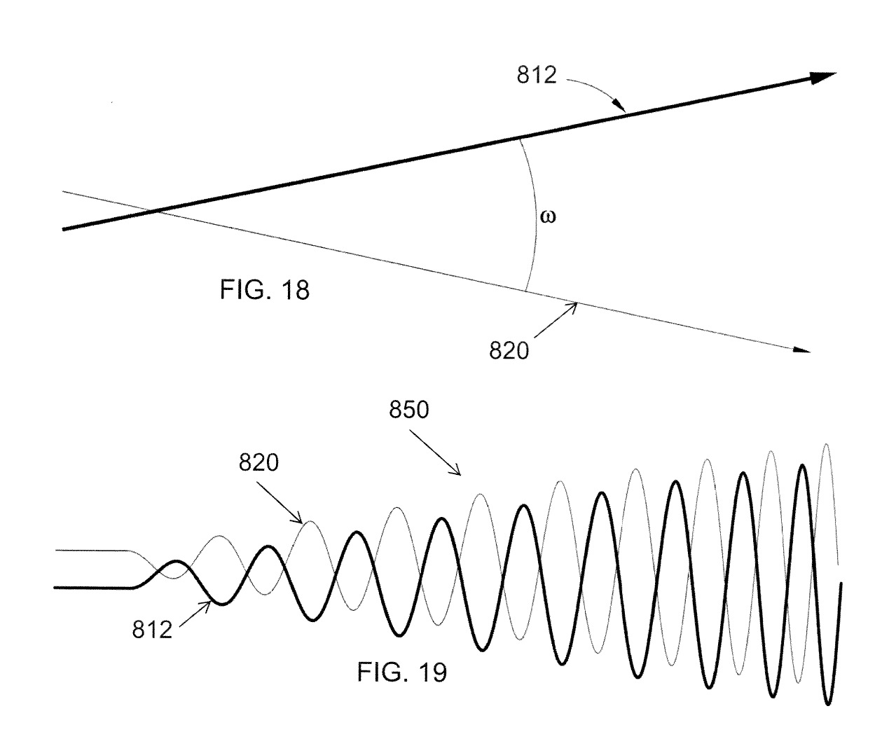

Referring to FIG. 18, post-turbine primary fluid stream 812 and secondary fluid stream 820 thus meet at an angle ω. Angle ω is typically between 10 and 50 degrees. The design of the mixer shroud 800 thus takes advantage of axial vorticity to mix the two fluid streams.

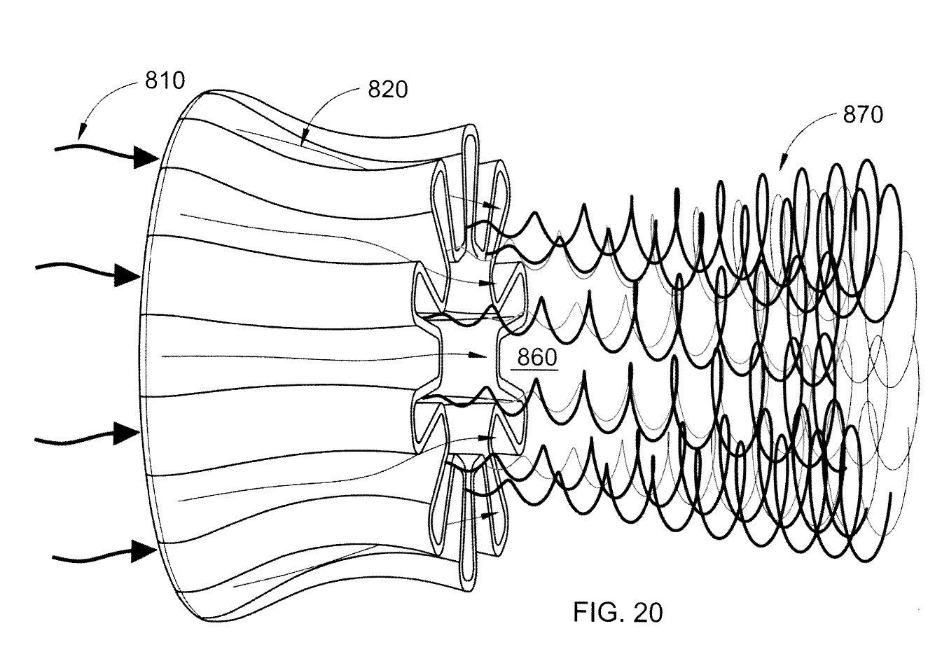

Referring to FIGS. 19 and 20, the meeting of the two fluid streams 812, 820 causes an “active” mixing of the two fluid streams. This differs from “passive” mixing which would generally occur only along the boundaries of two parallel fluid streams. In contrast, the active mixing here results in substantially greater energy transfer between the two fluid streams. This mixing is also known as “axial vorticity.” In addition, a volume of reduced or low pressure 860 results in the region downstream of or behind mixer shroud 800. The vortices and the reduced pressure downstream of the mixer shroud in turn pull or aspirate more fluid into primary fluid stream 810 and allow the power extraction unit/turbine stage to extract more energy from the incoming fluid. Put another way, the vortices and reduced pressure cause the primary fluid 810 upstream of the turbine stage to accelerate into the mixer shroud. Described differently, the reduced/low pressure causes additional fluid to be entrained through the mixer shroud rather than passing outside the mixer shroud.

FIG. 19 illustrates a vortex 850 formed by the meeting of reduced-energy fluid stream 812 and secondary fluid stream 820 around one mixer lobe. FIG. 20 shows the series of vortices formed by the plurality of mixer lobes 830 at the outlet 802 of the mixer shroud 800. The vortices are formed downstream or behind the mixer shroud 800. This combination may also be considered a first exit stream 870. Another advantage of this design is that the series of vortices formed by the active mixing reduce the distance downstream of the turbine in which turbulence occurs. With conventional open bladed wind turbines, the resulting downstream turbulence usually means that a downstream wind turbine must be placed a distance of 10 times the diameter of the upstream turbine away in order to reduce fatigue failure. In contrast, the presently disclosed turbines can be placed much closer together, allowing the capture of additional energy from the wind stream in a given area.

Alternatively, the mixer shroud 800 can be considered as separating incoming air into a first relatively fast fluid stream 810 and a second relatively fast fluid stream 820. The first fast fluid stream passes through the turbine stage and energy is extracted therefrom, resulting in a slower or reduced energy fluid stream 812 exiting the interior of the mixer shroud, which is relatively slower than the second fast fluid stream. The slower fluid stream 812 is then mixed with the second fast fluid stream 820.

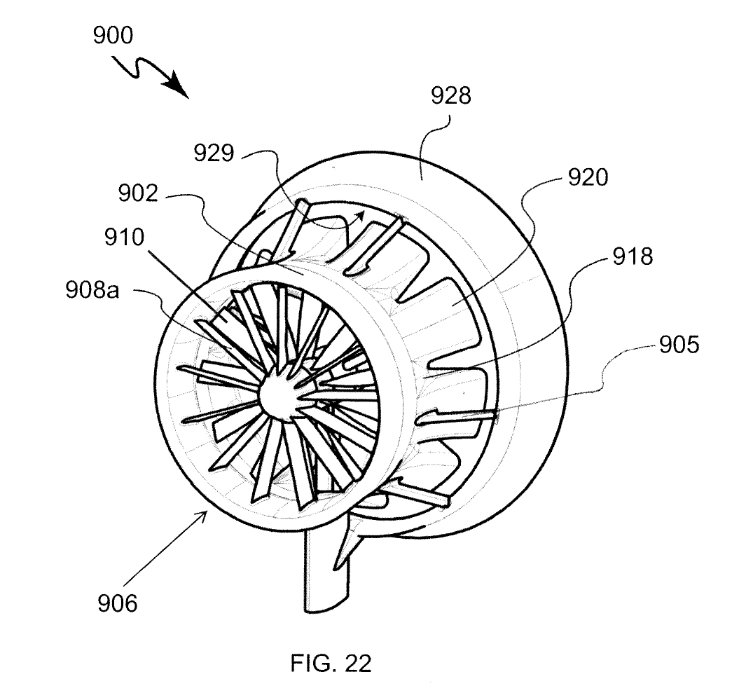

FIGS. 22-24 illustrate another exemplary embodiment of a MEWT. The MEWT 900 in FIG. 22 has a stator 908a and rotor 910 configuration for power extraction. A turbine shroud 902 surrounds the rotor 910 and is supported by or connected to the blades or spokes of the stator 908a. The turbine shroud 902 has the cross-sectional shape of an airfoil with the suction side (i.e. low pressure side) on the interior of the shroud. An ejector shroud 928 is coaxial with the turbine shroud 902 and is supported by connector members 905 extending between the two shrouds. An annular area is thus formed between the two shrouds. The rear or downstream end of the turbine shroud 902 is shaped to form two different sets of mixing lobes 918, 920. High energy mixing lobes 918 extend inwardly towards the central axis of the mixer shroud 902; and, low energy mixing lobes 920 extend outwardly away from the central axis.

Free stream air indicated generally by arrow 906 passing through the stator 908a has its energy extracted by the rotor 910. High energy air indicated by arrow 929 bypasses the shroud 902 and stator 908a and flows over the turbine shroud 902 and directed inwardly by the high energy mixing lobes 918. The low energy mixing lobes 920 cause the low energy air exiting downstream from the rotor 910 to be mixed with the high energy air 929.

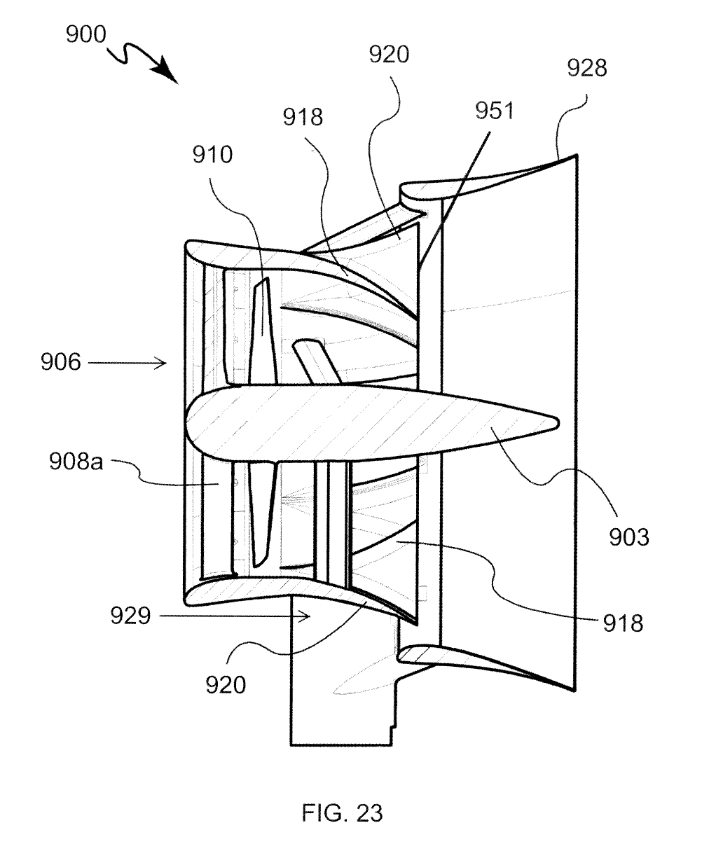

Referring to FIG. 23, the center nacelle 903 and the trailing edges of the low energy mixing lobes 920 and the trailing edge of the high energy mixing lobes 918 are shown in the axial cross-sectional view of the turbine of FIG. 22. The ejector shroud 928 is used to direct inwardly or draw in the high energy air 929. Optionally, nacelle 903 may be formed with a central axial passage therethrough to reduce the mass of the nacelle and to provide additional high energy turbine bypass flow.

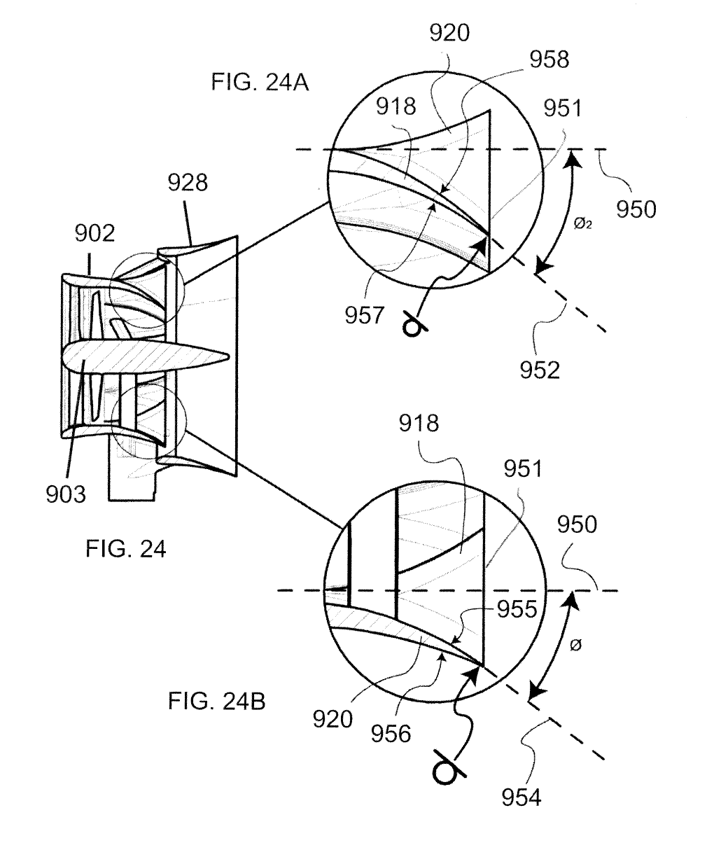

In FIG. 24A, a tangent line 952 is drawn along the interior trailing edge indicated generally at 957 of the high energy mixing lobe 918. A rear plane 951 of the turbine shroud 902 is present. A line 950 is formed normal to the rear plane 951 and tangent to the point where a low energy mixing lobe 920 and a high energy mixing lobe 918 meet. An angle Ø₂ is formed by the intersection of tangent line 952 and line 950. This angle Ø₂ is between 5 and 65 degrees. Put another way, a high energy mixing lobe 918 forms an angle Ø₂ between 5 and 65 degrees relative to the turbine shroud 902.

In FIG. 24B, a tangent line 954 is drawn along the interior trailing edge indicated generally at 955 of the low energy mixing lobe 920. An angle Ø is formed by the intersection of tangent line 954 and line 950. This angle Ø is between 5 and 65 degrees. Put another way, a low energy mixing lobe 920 forms an angle Ø between 5 and 65 degrees relative to the turbine shroud 902.

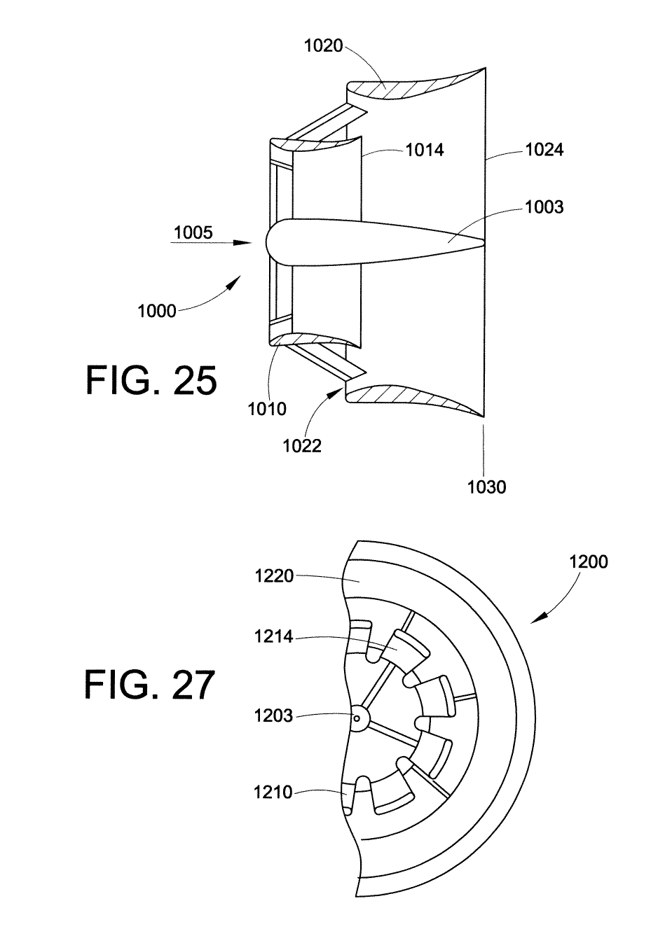

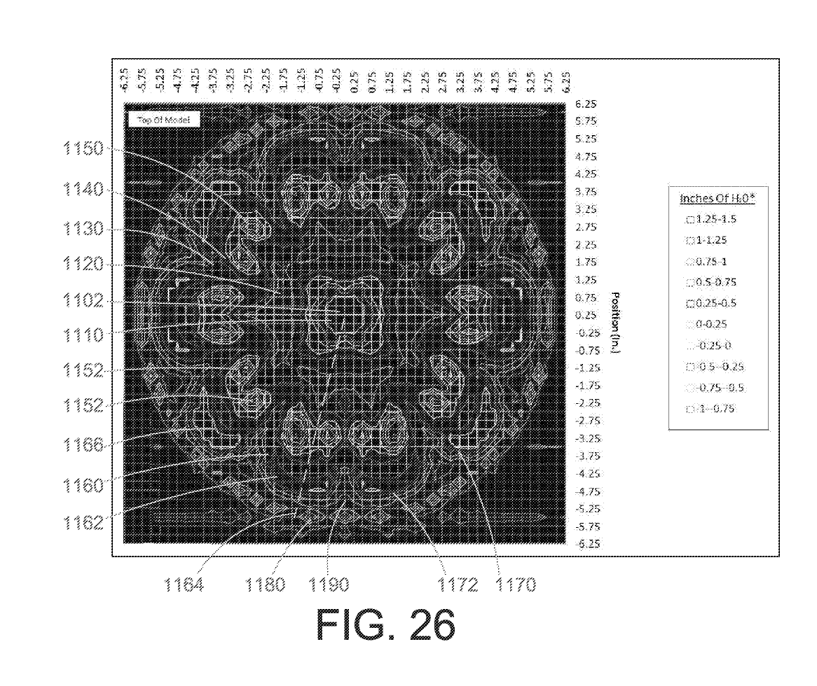

Referring now to FIGS. 25 and 26, the use of a turbine shroud with a set of mixing lobes causes active mixing, reducing the distance downstream of the turbine in which turbulence occurs. This also results in a unique pressure profile, or a signature pressure pattern, behind the shrouded wind turbine in an exit plane of the turbine. In particular, a mixture of high pressure regions and low pressure regions is formed. These regions are distinct and “mix out” faster than do the low pressure regions behind a HAWT. This pressure profile created by mixing lobes causes mix-out within a distance of less than 10 multiples of the ejector diameter.

FIG. 25 is a side cross-sectional view illustrating an exemplary shrouded wind turbine 1000. The turbine includes a center body 1003 surrounded by a turbine shroud 1010. An ejector shroud 1020 is located coaxial with and downstream of the turbine shroud. An outlet end 1014 of the turbine shroud 1010 extends into an inlet end 1022 of the ejector shroud 1020. The turbine shroud 1010 has ten low-energy mixing lobes and ten high-energy mixing lobes, arranged in a manner similar to the mixing lobes shown in FIGS. 10-14. An exit plane 1030 is defined at the outlet end 1024 of the ejector shroud, and is generally perpendicular to the direction of the wind indicated by arrow 1005. The ejector shroud itself has a continuous ring airfoil shape, and is shown here without mixing lobes.

FIG. 26 illustrates the pressure profile produced by the wind turbine 1000 of FIG. 25 in the exit plane 1030. The pressure profile was produced using a small scale model of the wind turbine. An automated traverse unit that traversed in the vertical and horizontal direction behind the MEWT small scale model was used to measure the total pressure in the exit plane. The measurements were conducted using a Kiel head probe because angularity was present in the exit plane flow. The pressure was measured with Omega PX277 differential pressure transducers that were open to atmospheric pressure, and the values shown in FIG. 26 were recorded as gauge pressure (psig). Due to time limitations, only one quarter of the exit plane was traversed in 0.25 inch increments for FIG. 26. The results were then mirrored to create a plot that displayed the pressure profile for the entire exit plane.

The pressure profile 1100 provides several different regions of pressure, corresponding to the number and placement of the mixing lobes of the wind turbine 1000. The x- and y-axes here refer to the location of the given pressure relative to the central axis of the turbine, along which the center body 1003 is located. The units provided in FIG. 26 are in inches of water (inches H₂O).

An inch of water is equivalent to 0.036 pounds per square inch (psi). As used herein, the term “psia” refers to the absolute pressure, or in other words the pressure measured relative to a vacuum. The term “psig” refers to the gauge pressure, or the pressure measured relative to the ambient pressure. At sea level, the atmospheric pressure would be zero psig, 14.7 psia, or approximately 408.3 inches of water (14.7/0.036).

The pressures discussed in the profiles described herein can be measured using several means, such as a static/dynamic probe, an ultrasonic probe, or a LIDAR probe. These means can be used to arrive at pressure measurements that are accurate to thousandths of psi's.

A first low pressure region 1110 is located in the center 1102 of the pressure profile. This first low pressure region is due to the presence of the center body 1003 and has a generally circular or elliptical shape. Surrounding the first low pressure region 1110 is a first high pressure region 1120. Surrounding the first high pressure region 1120 is a first mixed pressure ring 1130. The first mixed pressure ring 1130 comprises a plurality of high pressure pockets 1140 and a plurality of low pressure pockets 1150. The high pressure pockets alternate with the low pressure pockets around the mixed pressure ring. Put another way, each high pressure pocket 1140 is bracketed by two low pressure pockets 1150, and each low pressure pocket 1150 is bracketed by two high pressure pockets 1140. Each low pressure pocket 1150 may be made up of two low pressure nodes 1152.

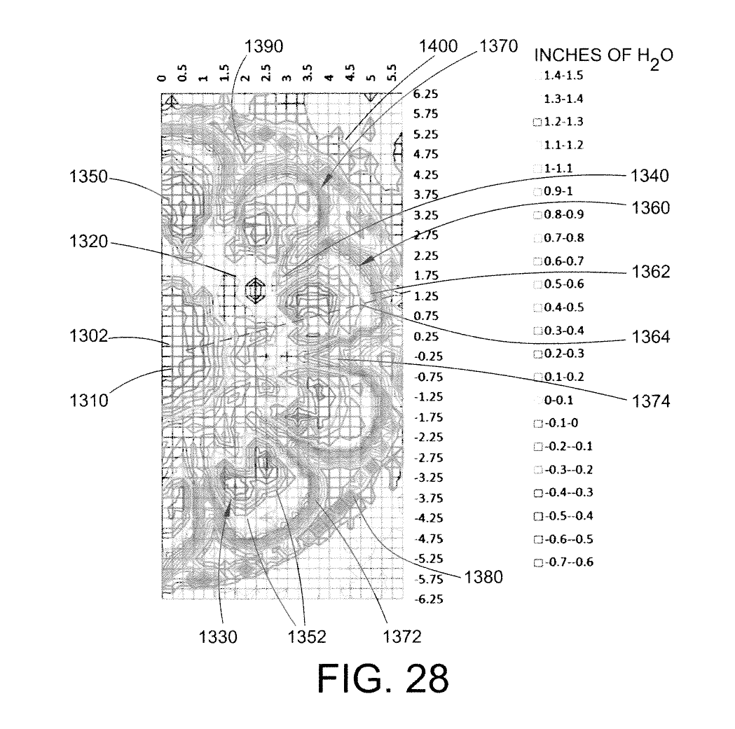

A second pressure ring 1160 surrounds the first mixed pressure ring 1130. This second pressure ring comprises a plurality of high pressure pockets 1162. Each high pressure pocket 1162 is aligned with a low pressure pocket 1150 in the first mixed pressure ring 1130. A high pressure pocket 1162 is considered to be aligned with a low pressure pocket 1150 when a radius (i.e. radial line) 1164 is drawn from the center 1102 outwards, and both the high pressure pocket 1162 and the low pressure pocket 1150 are located on the radius 1164. The second pressure ring may also include low pressure pockets 1166, although as will be seen in FIG. 28, such low pressure pockets need not be present.

Surrounding the first mixed pressure ring 1130 and the second pressure ring 1160 is a high pressure line 1170. The high pressure line 1170 has a circular crenellated shape similar to the trailing edge of the turbine shroud 1010 (compare FIG. 6). In particular, the high pressure line 1170 generally has one-half the number of nodes 1172 as the turbine shroud has mixing lobes. For example, the high pressure line 1170 here has ten nodes 1172 corresponding to the ten low-energy mixing lobes of the turbine shroud, and ten spaces 1174 between nodes corresponding to the ten high-energy mixing lobes of the turbine shroud 1010. The pressure of the high pressure line 1170 is greater than the pressure of the first high pressure region 1120 or the high pressure pockets 1140.

Surrounding the high pressure line 1170 is a set of high pressure spots 1180. Those high pressure spots 1180 are arranged in a circle and correspond to the ejector shroud 1020. The high pressure line 1170 and the high pressure spots 1180 generally have the same pressure. Between the high pressure line 1170 and the high pressure spots 1180 are high pressure gaps 1190. The pressure in the high pressure gaps 1190 is greater than the pressure of both the high pressure line 1170 and the high pressure spots 1180.

The first low pressure region 1110 and the first mixed pressure ring low pressure pockets 1150 each have a pressure of less than 0 psig. In particular versions or embodiments, these low pressure areas have a pressure of from −1 (negative one) psig to below 0 psig. It should be noted that the pressure in each low pressure area is not constant or uniform through the area, but rather is less than 0 psig.

Similarly, the first high pressure region 1120, the first mixed pressure ring high pressure pockets 1140, the second pressure ring high pressure pockets 1162, the high pressure line 1170, the high pressure spots 1180, and the high pressure gaps 1190 each have a pressure of 0 psig or greater. In particular versions or embodiments, these high pressure areas have a pressure of from 0 psig to 1.5 psig. It should also be noted that the first high pressure region 1120, the first mixed pressure ring high pressure pockets 1140, and the second pressure ring high pressure pockets 1162 are not physically distinct or separated from each other, but are only referred to in this manner for convenience. The first high pressure region 1120, the first mixed pressure ring high pressure pockets 1140, and the second pressure ring high pressure pockets 1162 generally have the same pressure.

FIG. 27 and FIG. 28 show another wind turbine with its related pressure profile. FIG. 27 is a front half-view into the outlet of the wind turbine 1200, and shows the turbine with a center body 1203 surrounded by a turbine shroud 1210. The turbine shroud 1210 has a total of ten low-energy mixing lobes 1214 with four full lobes and two half-lobes being visible in FIG. 27. An ejector shroud 1220 is located coaxial with and surrounding the turbine shroud 1210.

FIG. 28 illustrates the pressure profile produced by the wind turbine 1200. Again, the values shown here were recorded as gauge pressure (psig). The pressure profile was produced in the same manner in FIG. 26, except that one-half of the exit plane was traversed in 0.25 inch increments. FIG. 28 shows the one-half of the exit plane for which data was measured. Again, there are several different regions of pressure. The x- and y-axes here refer to the location of the given pressure relative to the central axis of the turbine (along which the center body 1003 is located). The units provided here are in inches of water again.

A first low pressure region 1310 is located in the center 1302 of the pressure profile. This first low pressure region is due to the presence of the center body 1203 and has a generally circular or elliptical shape. In this profile, the pressure in the first low pressure region reaches as low as −0.5 inches H₂O (−0.018 psig). Surrounding the first low pressure region 1310 is a first high pressure region 1320. The pressure in the first high pressure region is generally about 0 inches H₂O, although some parts go as high as 0.5 inches H₂O (0.018 psig). Surrounding the first high pressure region 1320 is a first mixed pressure ring 1330. The first mixed pressure ring 1330 comprises a plurality of high pressure pockets 1340 and a plurality of low pressure pockets 1350. The high pressure pockets alternate with the low pressure pockets around the mixed pressure ring. Put another way, each high pressure pocket 1340 is bracketed by two low pressure pockets 1350, and each low pressure pocket 1350 is bracketed by two high pressure pockets 1340. Each low pressure pocket 1350 may be made up of two low pressure nodes 1352. The pressure in the low pressure pockets again reaches as low as −0.5 inches H₂O, while the pressure in the high pressure pockets is generally about 0 inches H₂O.

A second pressure ring 1360 surrounds the first mixed pressure ring 1330. This second pressure ring comprises a plurality of high pressure pockets 1362. Each high pressure pocket 1362 is aligned with a low pressure pocket 1350 in the first mixed pressure ring 1330. A high pressure pocket 1362 is considered to be aligned with a low pressure pocket 1350 when a radius (i.e. radial line) 1364 is drawn from the center 1302 outwards, and both the high pressure pocket 1362 and the low pressure pocket 1350 are located on the radius 1364. The pressure in these high pressure pockets is generally about 0 inches H₂O

Surrounding the first mixed pressure ring 1330 and the second pressure ring 1360 is a high pressure line 1370. The high pressure line 1370 has a circular crenellated shape similar to the trailing edge of the turbine shroud 1010 (compare FIG. 6). In particular, the high pressure line 1370 generally has one-half the number of nodes 1372 as the turbine shroud has mixing lobes (both high energy and low energy mixing lobes). For example, the high pressure line 1370 here has ten nodes 1372 corresponding to the ten low-energy mixing lobes of the turbine shroud, and ten spaces 1374 between nodes corresponding to the ten high-energy mixing lobes of the turbine shroud 1010. Each node 1372 could also be considered as enclosing a low pressure pocket 1350 of the first mixed pressure ring 1330 and a high pressure pocket 1362 of the second pressure ring 1360. The pressure in the high pressure line varies between 0.6 and 1.1 inches H₂O (0.0216 to 0.0396 psig).

Surrounding the high pressure line 1370 is another set of high pressure spots 1380. Those high pressure spots 1380 are arranged in a circle and correspond to the ejector shroud 1020. The pressure in these high pressure spots also varies between 0.6 and 1.1 inches H₂O (0.0216 to 0.396 psig).

Between the high pressure line 1370 and the high pressure spots 1380 are high pressure gaps 1390. The pressure in the high pressure gaps 1390 is greater than the pressure of both the high pressure line 1370 and the high pressure spots 1380. The pressure in the high pressure gaps is usually at least 1.2 inches H₂O (0.0432 psig). The free wind or space outside the ejector shroud is indicated generally at 1400, and is also of higher pressure than both the high pressure line 1370 and the high pressure spots 1380, being usually at least 1.2 inches H₂O (0.0432 psig) in the vicinity of the ejector shroud.

It should be noted that the terms “low pressure” and “high pressure” are used in a relative sense. In addition, the various terms used for the different low pressure and high pressure areas should not be construed to require any particular shape for any given area of pressure, unless otherwise specified.

The first low pressure region 1310, first mixed pressure ring low pressure pockets 1350, and the high pressure line 1370 each have a pressure of less than 0 psig. In particular embodiments, these low pressure areas have a pressure of from −1 psig to less than 0 psig (−1≦pressure≦0 psig). It should be noted that the pressure in each low pressure area is not constant or uniform through the area, but rather is less than 0 psig.

Similarly, the first high pressure region 1320, the first mixed pressure ring high pressure pockets 1340, and the second pressure ring high pressure pockets 1362 each have a pressure of 0 psig or greater. In particular embodiments, these high pressure areas have a pressure of from 0 psig to 0.054 psig (0≦pressure≦0.054 psig). It should also be noted that the first high pressure region 1320, the first mixed pressure ring high pressure pockets 1340, and the second pressure ring high pressure pockets 1362 are not physically distinct or separated from each other, but are only referred to in this manner for convenience. Again, the pressure in each low pressure area is not constant or uniform through the area, but rather is at least 0 psig.

Generally speaking, the pressure profiles here show that high pressure air and low pressure air are being mixed quickly behind the wind turbine. This active mixing means that downstream wind turbines can be located more closely to the upstream wind turbine. This increases the density at which wind turbines can be placed in a given land surface area, increasing the amount of power generated by that land surface area.

The pressure profile may also be considered as having a plurality of mixed regions. Each mixed region is formed by at least a first low pressure region and a first high pressure region, which are mixed together. The number of mixed regions is equal to one-half the number of mixing lobes on the wind turbine. Referring again to FIG. 28, a mixed region may be considering as being made up from a second pressure ring high pressure pocket 1362 and a first mixed pressure ring low pressure pocket 1350. The mixed region can be considered as being the node 1372. The mixed regions (i.e. nodes) are arranged in a roughly circular shape around the center or central axis in the exit plane.

It should be noted that embodiments are contemplated which do not have an ejector shroud. In those embodiments, there would be no high pressure spots 1180, 1380 in the pressure profile.

It should be understood by those skilled in the art that modifications can be made without departing from the spirit or scope of the disclosure. Accordingly, reference should be made primarily to the appended claims rather than the foregoing description.

1. A wind turbine that produces a fluid pressure profile downstream of the turbine in an exit plane, the pressure profile comprising:
a first low pressure region defining a center of the pressure profile;
a first high pressure region surrounding the first low pressure region; and
a first mixed pressure ring surrounding the first high pressure region, the mixed pressure ring comprising a plurality of high pressure pockets and a plurality of low pressure pockets, the high pressure pockets and the low pressure pockets alternating around the mixed pressure ring.

2. The wind turbine of claim 1, wherein the pressure profile further comprises a second pressure ring surrounding the first mixed pressure ring, wherein the second pressure ring comprises a plurality of high pressure pockets, each high pressure pocket being aligned along a radius with a low pressure pocket in the first mixed pressure ring.

3. The wind turbine of claim 2, wherein the second pressure ring high pressure pockets have a pressure of at least 0 psig.

4. The wind turbine of claim 2, wherein the pressure profile further comprises a high pressure line surrounding the first mixed pressure ring and the second pressure ring, the high pressure line having a circular crenellated shape.

5. The wind turbine of claim 4, wherein the high pressure line has a pressure of at least 0 psig.

6. The wind turbine of claim 4, wherein the pressure profile further comprises a set of high pressure spots surrounding the high pressure line.

7. The wind turbine of claim 6, wherein the pressure profile further comprises high pressure gaps between the high pressure line and the high pressure spots, the high pressure gaps having a greater pressure than the high pressure line and the high pressure spots

8. The wind turbine of claim 1, wherein the first low pressure region has a pressure below 0 psig.

9. The wind turbine of claim 1, wherein the first low pressure region has a pressure from at least −1 psig to less than 0 psig.

10. The wind turbine of claim 1, wherein the first high pressure region has a pressure of at least 0 psig.

11. The wind turbine of claim 1, wherein the first high pressure region has a pressure from 0 psig to 0.054 psig.

12. The wind turbine of claim 1, wherein the high pressure pockets in the first mixed pressure ring have a pressure of at least 0 psig.

13. The wind turbine of claim 1, wherein the high pressure pockets in the first mixed pressure ring have a pressure from 0 psig to 0.054 psig.

14. The wind turbine of claim 1, wherein the low pressure pockets in the first mixed pressure ring have a pressure from at least −1 psig to less than 0 psig.

15. A wind turbine that produces a fluid pressure profile downstream of the turbine in an exit plane, the pressure profile comprising:
a first low pressure region defining a center of the pressure profile;
a first high pressure region surrounding the first low pressure region;
a first mixed fluid pressure ring surrounding the first high pressure region, the mixed pressure ring comprising a plurality of high pressure pockets and a plurality of low pressure pockets, the high pressure pockets and the low pressure pockets alternating around the mixed pressure ring;
a second fluid pressure ring surrounding the first mixed pressure ring, wherein the second pressure ring comprises a plurality of high pressure pockets, each high pressure pocket being aligned along a radius with a low pressure pocket in the first mixed pressure ring; and
a high pressure line surrounding the first mixed pressure ring and the second pressure ring, the high pressure line having a circular crenellated shape.

16. A method of making a wind turbine comprising:
(a) providing an impeller that rotates about a horizontal axis;
(b) surrounding the impeller with a turbine shroud, the shroud having an airfoil cross-section shape and reducing the pressure of the wind stream passing through the impeller;
(c) disposing an ejector shroud co-axially with and downstream of the turbine shroud; and
(d) forming a plurality of spaced radially inwardly extending mixing lobes and a plurality of radially outwardly extending mixing lobes on a downstream edge of the turbine shroud, the inwardly extending mixing lobes alternating with the outwardly extending mixing lobes about the downstream edge.

17. The method of claim 16, wherein the step of forming inwardly extending lobes and outwardly extending lobes includes crenellating the downstream edge of the turbine shroud.

18. The method of claim 16, wherein the step of surrounding the impeller with a turbine shroud includes forming a skeleton from a rigid material and covering at least a portion of the skeleton with a skin, the skin comprising a fabric or a polymer film.

19. The method of claim 18, wherein the skin has multiple layers.

20. The method of claim 16, wherein the step of disposing an ejector shroud includes forming an ejector shroud skeleton from a rigid material and covering at least a portion of the ejector shroud skeleton with a skin, the skin comprising a fabric or a polymer film.

21. The method of claim 20, wherein the skin has multiple layers.

22. The method of claim 16, wherein the impeller is a rotor/stator assembly.

23. The method of claim 16, wherein the inwardly extending mixing lobes and the outwardly extending mixing lobes are independently formed to make an angle of from 5 to 65 degrees relative to the horizontal axis.

24. The method of claim 16, wherein an area ratio, defined by an ejector shroud exit area divided by a turbine shroud exit area, has a value of from 1.5 to 4.0.

25. The method of claim 16, wherein the turbine shroud has a total of from 6 to 14 mixing lobes.

26. A wind turbine with mixing lobes that produces a fluid pressure profile downstream of the turbine in an exit plane, the pressure profile comprising:
a plurality of mixed regions, a mixed region being formed by a first low pressure region mixed with a first high pressure region;
wherein the number of mixed regions is equal to one-half the number of mixing lobes.

27. The wind turbine of claim 26, wherein the mixed regions are arranged in a circle around a central axis in the exit plane.

28. A wind turbine that produces a pressure profile in an exit plane as shown in FIG. 1 or FIG. 2.
